(19) United States
(12) Patent Application Publication
(10) Pub. No.: US 2014/0320764 A1
(43) Pub. Date: Oct. 30, 2014

(54) TOUCH DISPLAY APPARATUS

(71) Applicant: InnoLux Corporation, Miao-Li County (TW)

(72) Inventors: Wen-Jyh SAH, Miao-Li County (TW); Cheng-Hsia KUO, Miao-Li County (TW); Ching-Hsin WU, Miao-Li County (TW)

(73) Assignee: InnoLux Corporation, Miao-Li County (TW)

(21) Appl. No.: 14/252,143

(22) Filed: Apr. 14, 2014

(30) Foreign Application Priority Data
Apr. 30, 2013 (TW) 102115497

(51) Int. Cl. G06F 1/16

(52) U.S. Cl. CPC G06F 1/1643
USPC 349/12

(57) ABSTRACT

A touch display apparatus comprises a touch display panel, a first control circuit board, a first circuit connection board, a second circuit connection board and a system circuit board. The touch display panel includes a touch panel and a display panel which are disposed oppositely. The first control circuit board is electrically connected to the touch panel through the first circuit connection board. The first control circuit board is electrically connected to the display panel through the second circuit connection board. The system circuit board is electrically connected to the first control circuit board.

### CROSS REFERENCE TO RELATED APPLICATIONS

This Non-provisional application claims priority under 35 U.S.C. §119(a) on Patent Application No(s). 102115497 filed in Taiwan, Republic of China on Apr. 30, 2013, the entire contents of which are hereby incorporated by reference.

### BACKGROUND OF THE INVENTION

1. Field of Invention

The invention relates to a touch display apparatus.

2. Related Art

With the progress of technologies, various novel information apparatuses, such as cell phones, tablet computers, ultrabooks and GPS navigation apparatuses, are invented. Generally, a keyboard and a mouse are commonly used to manipulate the information apparatus for inputting information. Nevertheless, the touch control technology currently also becomes a popular manipulation method for the information apparatus with an intuitive operation. Accordingly, a touch display apparatus using the touch control technology can provide a friendly and intuitive interface for the input operation, while a user can manipulate the touch display apparatus by fingers or a stylus.

Generally, the touch display apparatus can be divided into two kinds, the one is an in-cell touch display apparatus where a sensing electrode layer is disposed within the display panel (e.g. LCD panel), and the other one is an on-cell touch display apparatus where a touch panel is disposed on the display panel.

For a conventional on-cell touch display apparatus, the circuit (such as a touch control IC) for controlling the touch panel is disposed on a circuit board and the circuit (such as a data driving circuit and a timing control circuit) for controlling the display panel is disposed on another circuit board. However, this will increase the cost of the touch display apparatus and thus lower down the competitiveness of the touch display apparatus.

Therefore, it is an important subject to provide a touch display apparatus that has lower manufacturing cost and higher competitiveness.

### SUMMARY OF THE INVENTION

An objective of the invention is to provide a touch display apparatus that has lower manufacturing cost and higher competitiveness.

To achieve the above objective, a touch display apparatus according to the invention comprises a touch display panel, a first control circuit board, a first circuit connection board, a second circuit connection board and a system circuit board. The touch display panel includes a touch panel and a display panel which are disposed oppositely. The first control circuit board is electrically connected to the touch panel through the first circuit connection board. The first control circuit board is electrically connected to the display panel through the second circuit connection board. The system circuit board is electrically connected to the first control circuit board.

In one embodiment, the first or second circuit connection board includes a chip on film (COF), a tape automatic bonding (TAB), a flexible printed circuit (FPC) or a rigid-flex board.

In one embodiment, the connection between the first control circuit board and the first or second circuit connection board is achieved by thermocompression bonding, adhesion or using a connection terminal, or their combinations.

In one embodiment, the touch display panel further includes a touch circuit, which is disposed on the first control circuit board or touch panel and electrically connected to the touch panel.

In one embodiment, the first circuit connection board has 4-6 pins.

In one embodiment, the touch display panel further includes a timing control circuit, which is disposed on the display panel or the first control circuit board and electrically connected to the display panel.

In one embodiment, the touch display panel further includes a data driving circuit, which is disposed on the display panel or the second circuit connection board and electrically connected to the display panel.

In one embodiment, the touch display panel further includes a scan driving circuit electrically connected to the display panel.

In one embodiment, the touch display apparatus further comprises a third circuit connection board electrically connected to the display panel.

In one embodiment, the scan driving circuit is disposed on the third circuit connection board or the display panel.

In one embodiment, the touch display apparatus further comprises a second control circuit board disposed adjacent to the touch display panel. The third circuit connection board is connected to the display panel and the second control circuit board, and the second control circuit board is electrically connected to the display panel through the third circuit connection board.

In one embodiment, the scan driving circuit is disposed on the third circuit connection board or the second control circuit board.

As mentioned above, in the touch display apparatus according to the invention, the first control circuit board is electrically connected to the touch panel through the first circuit connection board and electrically connected to the display panel through the second circuit connection board. Besides, the system circuit board is electrically connected to the first control circuit board. Thereby, the touch display panel can be controlled in the invention just by the system circuit board and a single first control circuit board, in comparison with the prior art. Therefore, the touch display apparatus of the invention has lower cost and higher competitiveness. Moreover, in one embodiment of the invention, the data driving circuit and timing control circuit for driving the display panel can be disposed on the display panel. Thereby, the number and the connection width of the second circuit connection board can be both decreased, and the size of the control circuit board also can be reduced. Accordingly, the cost of the touch display apparatus can be lowered down further. In one embodiment of the invention, the touch circuit for driving touch panel can be disposed on the touch panel. Thereby, the connection width of the first circuit connection board and the size of the control circuit board can be reduced, and therefore the cost of the touch display apparatus can be lowered down further.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of a touch display apparatus according to a preferred embodiment of the invention; and

FIGS. 1B to 1H are schematic diagrams showing some variations of the touch display apparatus according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

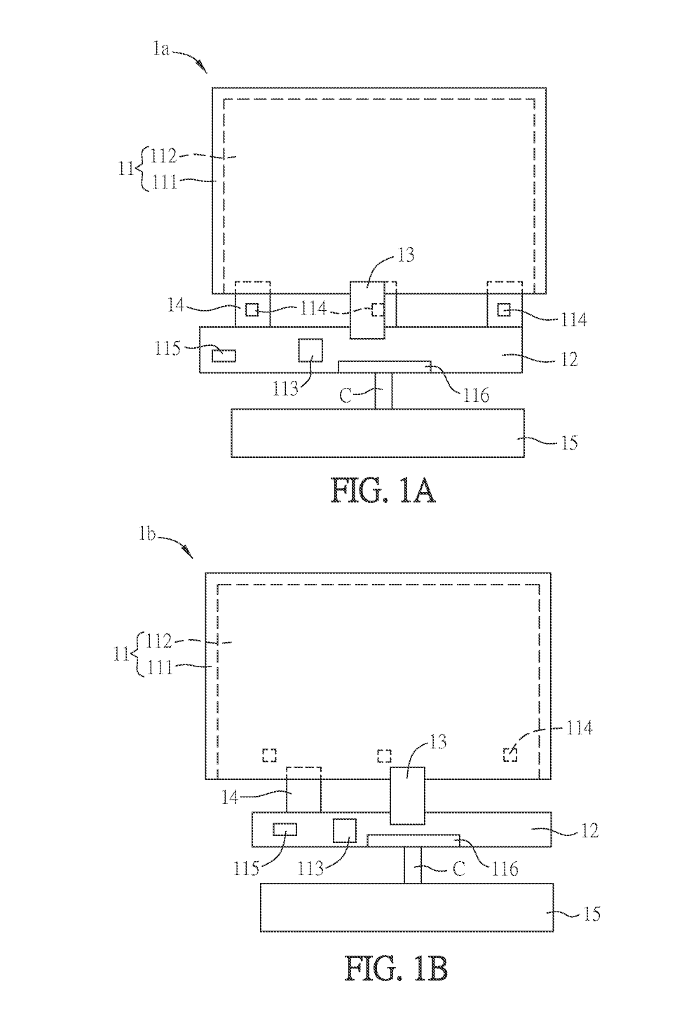

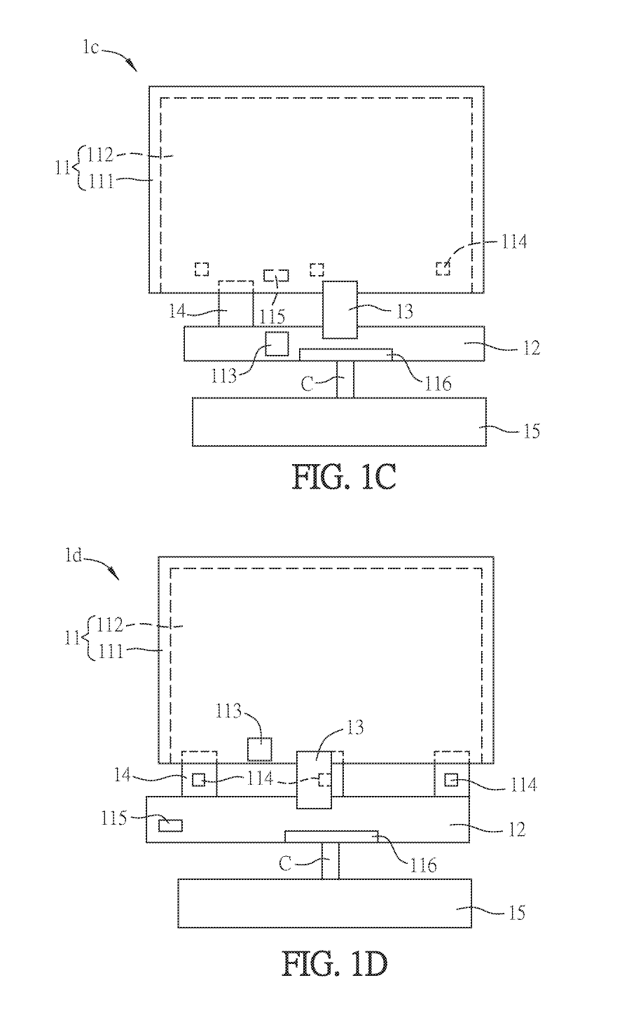

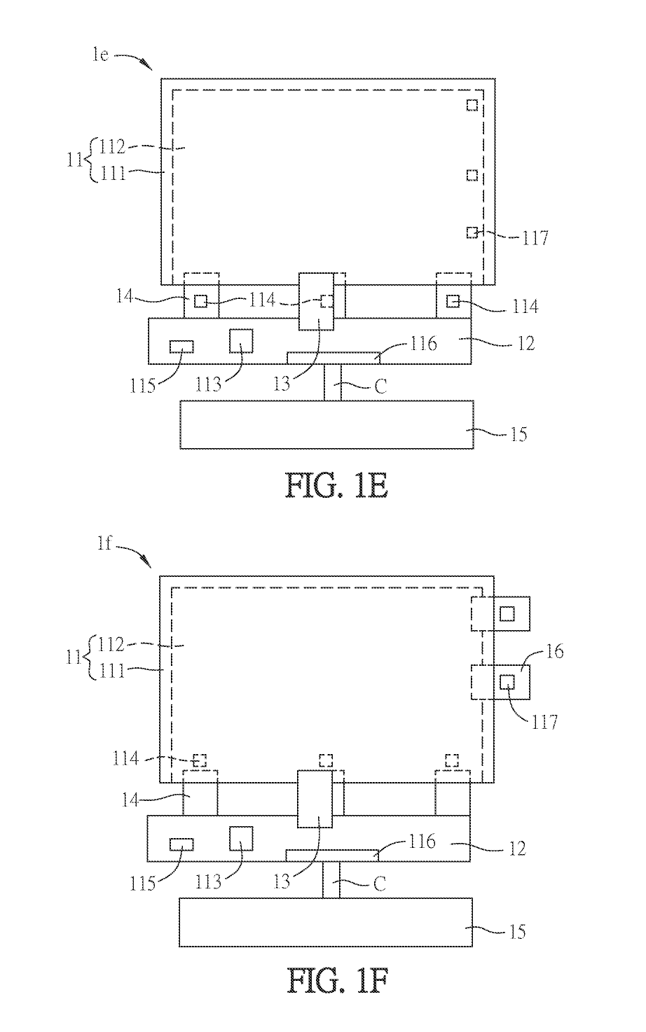

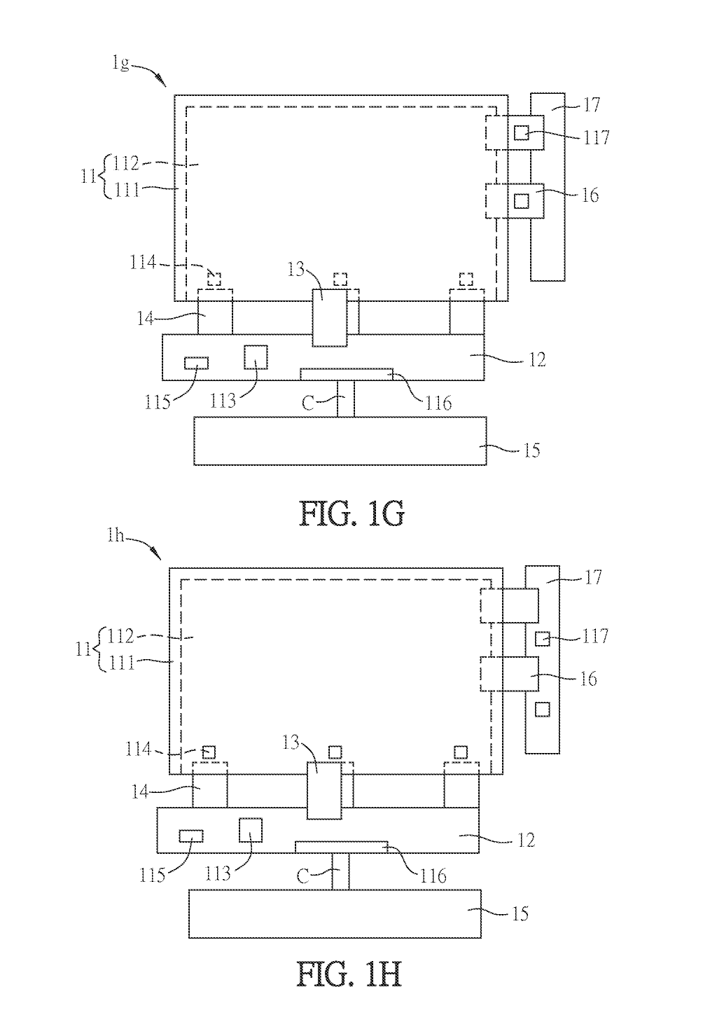

FIG. 1A is a schematic diagram of a touch display apparatus 1a according to a preferred embodiment of the invention.

In FIG. 1A, the touch display apparatus 1a includes a touch display panel 11, a first control circuit board 12, a first circuit connection board 13, a second circuit connection board 14 and a system circuit board 15.

The touch display panel 11 includes a touch panel 111 and a display panel 112, which are disposed opposite to each other. In this embodiment, the dimensions (area) of the touch panel 111 are greater than the dimensions (area) of the display panel 112. In other embodiments, however, the area of the touch panel 111 can be equal to or less than that of the display panel 112. The touch panel 111 can be disposed on the display panel 112 by adhesion or other connection mechanisms. In the case of adhesion, the touch panel 111 can be connected to the display panel 112 through an adhering material (not shown) by the direct bonding. Otherwise, the touch panel 111 can be connected to the display panel 112 by the air bonding.

The display panel 112 is, in an unlimited aspect, an LCD panel or an OLED display panel. In this embodiment, the display panel 112 is an LCD panel for example. The LCD panel includes a first substrate and a second substrate (not shown) which are disposed opposite to each other. Herein, the first substrate, the second substrate and the touch panel 111 can include a glass material each, and the glass materials thereof can be the same or different. If the first substrate is a thin film transistor (TFT) substrate, the second substrate is a color filter (CF) substrate. The LCD panel further includes a liquid crystal layer (not shown), which is disposed between the first and second substrates. The LCD panel further includes an upper polarizer and a lower polarizer. The upper polarizer is disposed between the second substrate and the touch panel 111, and the lower polarizer is disposed under the first substrate. Moreover, the touch display apparatus 1a can further include a backlight module (not shown), which is disposed opposite to the LCD panel (the display panel 112). The backlight module emits light to the display panel 112 so that the display panel 112 can display images.

The first control circuit board 12 is disposed adjacent to the touch display panel 11. The first control circuit board 12 is electrically connected to the touch display panel 11 and includes the control circuit for driving the touch panel 111 and display panel 112.

The first circuit connection board 13 is connected to the touch panel 111 and the first control circuit board 12. The first circuit connection board 13 can be connected to an upper surface or a lower surface of the touch panel 111. Herein as an example, a single first circuit connection board 13 is connected to the upper surface of the touch panel 111. The first control circuit board 12 is electrically connected to the touch panel 111 through the first circuit connection board 13. In this embodiment, the touch display panel 11 further includes a touch circuit 113, which is disposed on the first control circuit board 12 and electrically connected to the touch panel 111. The touch circuit 113 is, for example but not limited to, a touch control IC. The touch panel 111 can be controlled by the touch circuit 113 and the first circuit connection board 13.

The second circuit connection board 14 is connected to the display panel 112 and the first control circuit board 12. Herein, the second circuit connection board 14 is connected to the surface (e.g. the upper surface) of the display panel 112 facing the touch panel 111. The first control circuit board 12 is electrically connected to the display panel 112 through the second circuit connection board 14. There are three second circuit connection boards 14 in this embodiment for example. The connection between the first control circuit board 12 and the first or second circuit connection board 13 or 14 can be achieved by thermocompression bonding, adhesion (e.g. by a silver paste) or using a connection terminal, for example. Moreover, the first or second circuit connection board 13 or 14 is, for example, a chip on film (COF), a tape automatic bonding (TAB), a flexible printed circuit (FPC) or a rigid-flex board. Herein as an example, the first circuit connection board 13 is an FPC and the second circuit connection board 14 is a COF.

The touch display panel 11 further includes a scan driving circuit (not shown), which is electrically connected to the display panel 112. In this embodiment, the scan driving circuit is formed on the glass substrate of the display panel 112 by the TFT process including the GOP (gate on panel) technique for saving the cost of the scan driving IC. The touch display panel 11 further includes a data driving circuit 114, which is disposed on the second circuit connection board 14 and electrically connected to the display panel 112. The data driving circuit 114 can include at least a data driving IC for driving the display panel 112. Herein as an example, there are three data driving circuits 114 disposed on the second circuit connection boards 14 respectively. The touch display panel 11 further includes a timing control circuit (T-con) 115 and a connection port 116, which are both disposed on the first control circuit board 12. The timing control circuit 115 is electrically connected to the display panel 112, the data driving circuit 114 and the scan driving circuit, and can control the timing of the display panel 112. The timing control circuit 115 can transmit the vertical clock signal and the vertical synchronization signal to the scan driving circuit, convert the video signal from the outside into the data signal used for the data driving circuit 114, and transmit the data signal, horizontal clock signal and horizontal synchronization signal to the data driving circuit 114. The connection port 116 is, for example but not limited to, a low-voltage differential signaling (LVDS) port or an embedded display port (eDP).

The system circuit board 15 is electrically connected to the first control circuit board 12. The system circuit board 15 is electrically connected to the connection port 116 of the first control circuit board 12 through a connection wire C for example. The system circuit board 15 includes a control assembly of the touch display apparatus 1a, and the control assembly includes, for example, CPU, main memory, register, bus and other control or connection devices. The system circuit board 15 can output the image signal for driving the display panel 112 to the first control circuit board 12 so as to drive the display panel 112 to display images through the first control circuit board 12 and the second circuit connection board 14. Furthermore, the system circuit board 15 can receive the touch coordinates transmitted by the touch circuit 113, and thus control the display panel 112 through the first control circuit board 12 so that the display panel 112 can perform functions accordingly.

As mentioned above, in the touch display apparatus 1a of the invention, the touch display panel 11 can be controlled just by a system circuit board 15 and a first control circuit board 12. In comparison with the prior art, the touch display apparatus 1a has the lower cost and higher competitiveness.

FIGS. 1B to 1H are schematic diagrams showing some variations 1b-1h of the touch display apparatus according to a preferred embodiment of the invention.

As shown in FIG. 1B, mainly different from the touch display apparatus 1a, the data driving circuit 114 of the touch display apparatus 1b is disposed on the display panel 112. Herein, the data driving circuit 114 including at least a data driving IC is formed on the display panel 112 by the COG (chip on glass) technique. Thereby, the number and the connection width (i.e. concerning the number of the pins) of the second circuit connection board 14 can be decreased (only one second circuit connection board 14 is shown in FIG. 1B), and the area of the first control circuit board 12 can be reduced. Therefore, the cost of the touch display apparatus 1b can be decreased.

The technical features of other devices of the touch display apparatus 1b can be comprehended by referring to the touch display apparatus 1a, and therefore they are not described here for conciseness.

As shown in FIG. 1C, mainly different from the touch display apparatus 1b, the timing control circuit 115 of the touch display apparatus 1c is disposed on the display panel 112. Thereby, the connection width (i.e. concerning the number of the pins) of the second circuit connection board 14 and the area of the first control circuit board 12 can be reduced. Therefore, the cost of the touch display apparatus 1c can be decreased. In other embodiments, if the data driving circuit 114 includes the timing control circuit 115, the connection width of the second circuit connection board 14 and the area of the first control circuit board 12 also can be reduced.

The technical features of other devices of the touch display apparatus 1c can be comprehended by referring to the touch display apparatus 1b, and therefore they are not described here for conciseness.

As shown in FIG. 1D, mainly different from the touch display apparatus 1a, the touch circuit 113 of the touch display apparatus 1d is disposed on the display panel 112. Herein, the touch circuit 113 (driver IC) can be disposed on the display panel 112 by the COG technique. Thereby, the connection width with the number of the pins of the first circuit connection board 13 can be reduced. For example, the first circuit connection board 13 may have 4˜6 pins. Therefore, the cost of the touch display apparatus 1d can be decreased.

The technical features of other devices of the touch display apparatus 1d can be comprehended by referring to the touch display apparatus 1a, and therefore they are not described here for conciseness.

As shown in FIG. 1E, mainly different from the touch display apparatus 1a, a scan driving circuit 117 of the touch display apparatus 1e is disposed on the display panel 112. Herein, there are three scan driving circuits 117 for example. The scan driving circuits 117 (driver ICs) are disposed on the display panel 112 by the COG technique for example.

The technical features of other devices of the touch display apparatus 1e can be comprehended by referring to the touch display apparatus 1a, and therefore they are not described here for conciseness.

As shown in FIG. 1F, mainly different from the touch display apparatus 1e, the touch display apparatus if further includes a third circuit connection board 16 electrically connected to the display panel 112. Herein for example, there are two third circuit connection boards 16 connected to the display panel 112. The third circuit connection board 16 is, for example, a COF, TAB, FPC or rigid-flex board. In this embodiment, the third circuit connection board 16 is a COF for example. Moreover, two scan driving circuits 117 are provided in this embodiment and they are disposed on the third circuit connection boards 16 respectively. The scan driving circuits 117 (driver ICs) can be disposed on the third circuit connection board 16 by the COF technique. Besides, the data driving circuits 114 of the touch display apparatus if are disposed on the display panel 112. The data driving circuits 114 including the data driving ICs are disposed on the display panel 112 by the COF technique.

The technical features of other devices of the touch display apparatus if can be comprehended by referring to the touch display apparatus 1e, and therefore they are not described here for conciseness.

As shown in FIG. 1G, mainly different from the touch display apparatus 1f, the touch display apparatus 1g further includes a second control circuit board 17. The second control circuit board 17 is disposed adjacent to the touch display panel 11, and the third circuit connection board 16 is connected to the display panel 112 and the second control circuit board 17. The second control circuit board 17 is electrically connected to the display panel 112 through the third circuit connection board 16. The second control circuit board 17 can include the circuit for driving the display panel 112, such as a gamma correction circuit.

The technical features of other devices of the touch display apparatus 1g can be comprehended by referring to the touch display apparatus 1f, and therefore they are not described here for conciseness.

As shown in FIG. 1H, mainly different from the touch display apparatus 1g, the scan driving circuit 117 of the touch display apparatus 1h is disposed on the second control circuit board 17, and is electrically connected to the display panel 112 through the third circuit connection board 16 to drive the display panel 112.

The technical features of other devices of the touch display apparatus 1h can be comprehended by referring to the touch display apparatus 1g, and therefore they are not described here for conciseness.

In summary, in the touch display apparatus according to the invention, the first control circuit board is electrically connected to the touch panel through the first circuit connection board and electrically connected to the display panel through the second circuit connection board. Besides, the system circuit board is electrically connected to the first control circuit board. Thereby, the touch display panel can be controlled in the invention just by the system circuit board and a single first control circuit board, in comparison with the prior art. Therefore, the touch display apparatus of the invention has the lower cost and higher competitiveness. Moreover, in one embodiment of the invention, the data driving circuit and timing control circuit for driving the display panel can be disposed on the display panel. Thereby, the number and the connection width of the second circuit connection board can be both decreased, and the size of the control circuit board also can be reduced. Accordingly, the cost of the touch display apparatus can be lowered down further. In one embodiment of the invention, the touch circuit for driving touch panel can be disposed on the touch panel. Thereby, the connection width of the first circuit connection board and the size of the control circuit board can be reduced, and therefore the cost of the touch display apparatus can be lowered down further.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch display apparatus, comprising:
a touch display panel including a touch panel and a display panel which are disposed oppositely;
a first control circuit board;
a first circuit connection board, wherein the first control circuit board is electrically connected to the touch panel through the first circuit connection board;
a second circuit connection board, wherein the first control circuit board is electrically connected to the display panel through the second circuit connection board; and
a system circuit board electrically connected to the first control circuit board.

2. The touch display apparatus as recited in claim 1, wherein the first or second circuit connection board includes a chip on film (COF), a tape automatic bonding (TAB), a flexible printed circuit (FPC) or a rigid-flex board.

3. The touch display apparatus as recited in claim 1, wherein the connection between the first control circuit board and the first or second circuit connection board is achieved by thermocompression bonding, adhesion or using a connection terminal, or their combinations.

4. The touch display apparatus as recited in claim 1, wherein the touch display panel further includes a touch circuit, which is disposed on the first control circuit board or touch panel and electrically connected to the touch panel.

5. The touch display apparatus as recited in claim 4, wherein the first circuit connection board has 4˜6 pins.

6. The touch display apparatus as recited in claim 1, wherein the touch display panel further includes a timing control circuit, which is disposed on the display panel or the first control circuit board and electrically connected to the display panel.

7. The touch display apparatus as recited in claim 1, wherein the touch display panel further includes a data driving circuit, which is disposed on the display panel or the second circuit connection board and electrically connected to the display panel.

8. The touch display apparatus as recited in claim 1, wherein the touch display panel further includes a scan driving circuit electrically connected to the display panel.

9. The touch display apparatus as recited in claim 8, further comprising:
a third circuit connection board electrically connected to the display panel.

10. The touch display apparatus as recited in claim 9, wherein the scan driving circuit is disposed on the third circuit connection board or the display panel.

11. The touch display apparatus as recited in claim 9, further comprising:
a second control circuit board disposed adjacent to the touch display panel, wherein the third circuit connection board is connected to the display panel and the second control circuit board, and the second control circuit board is electrically connected to the display panel through the third circuit connection board.

12. The touch display apparatus as recited in claim 11, wherein the scan driving circuit is disposed on the third circuit connection board or the second control circuit board.
